(19) United States
(12) Patent Application Publication
(10) Pub. No.: US 2008/0225941 A1
(43) Pub. Date: Sep. 18, 2008

(54) MOVING PICTURE CONVERTING APPARATUS, MOVING PICTURE TRANSMITTING APPARATUS, AND METHODS OF CONTROLLING SAME

(76) Inventor: Akira HINO, Asaka-shi (JP)

Correspondence Address: BIRCH STEWART KOLASCH & BIRCH, PO BOX 747, FALLS CHURCH, VA, 22040-0747, US

(21) Appl. No.: 12/031,545

(22) Filed: Feb. 14, 2008

(30) Foreign Application Priority Data
Mar. 15, 2007 (JP) 2007-065956

(51) Int. Cl. H04B 1/66

(52) U.S. Cl. 375/240.01; 375/E07.001

(57) ABSTRACT

Moving-picture-with-audio data suitable for reproduction at a terminal device is generated rapidly. Image data, which represents a moving picture from which audio has been removed, and audio data are extracted from moving-picture-with-audio data by an image extracting unit and audio extracting unit. The items of extracted image data and audio data are respectively converted by an image converting unit and audio converting unit to image data and audio data having formats of a plurality of types suitable for reproduction and output by every model of terminal device. The items of image data and audio data obtained by the conversions are stored in an image database and audio data base, respectively. When the moving-picture-with-audio data is to be transmitted, items of image data and audio data suited to a terminal device to which the transmission is to be made are read out and the moving-picture-with-audio data is generated. The moving-picture-with-audio data thus generated is transmitted to the terminal device to which the transmission is to be made.

### BACKGROUND OF THE INVENTION

1. Field of the Invention

This invention relates to a moving picture converting apparatus, a moving picture transmitting apparatus and methods of controlling these.

2. Description of the Related Art

It has become possible to transmit moving picture data with audio to a terminal device such as a mobile telephone. The formats of audio and images capable of being reproduced by a mobile telephone depend upon the model of the mobile telephone. Since there are a wide variety of mobile telephones available, it is required that the moving-picture-with-audio data be converted in accordance with the model of the mobile telephone. To achieve this, there are arrangements in which a conversion is made to a format capable of being processed at the destination of the transmission (see the specifications of Japanese Patent Application Laid-Open Nos. 2006-11757 and 2002-152301). However, since it is difficult to perform a format conversion quickly, often a moving picture with audio cannot be reproduced rapidly.

Further, there is an arrangement in which data of a number of formats corresponding to devices at the destinations of a transmission is generated in advance and then transmitted in response to a request (see the specification of Japanese Patent Application Laid-Open No. 2001-290694). However, data of a very large number of formats must be generated in advance.

Furthermore, there is an arrangement in which a conversion to data of a predetermined format is made on the transmitting side, the data is transmitted and the data of this predetermined format is converted to data of the desired format on the receiving side (see the specification of Japanese Patent Application Laid-Open No. 2005-108253). However, this expedient is comparatively troublesome since it is necessary to decide beforehand to send and receive data of a predetermined format on both the transmitting and receiving sides.

### SUMMARY OF THE INVENTION

Accordingly, an object of the present invention is to so arrange it that an apparatus on the receiving side can reproduce a moving picture with audio rapidly in comparatively simple fashion.

According to a first aspect of the present invention, the foregoing object is attained by providing a moving picture converting apparatus comprising: an audio data extracting device (means) for extracting audio data representing audio from moving-picture-with-audio data representing a moving picture to which audio has been added; an image data extracting device (means) for extracting image data representing an image from the moving-picture-with-audio data; an audio data converting device (means) for converting the audio data that has been extracted by the audio data extracting device to audio data of formats of a plurality of types suitable for audio output in a plurality of types of transmission-target terminal devices to which the moving-picture-with-audio data is to be transmitted; an image data converting device (means) for converting the image data that has been extracted by the image data extracting device to image data of formats of a plurality of types suitable for reproduction of a moving picture in the plurality of types of transmission-target terminal devices; an audio data storage control device (means) for controlling an audio data storage device in such a manner that a plurality of items of audio data converted to the audio data of the formats of the plurality of types by the audio data converting device are stored in association with data specifying corresponding transmission-target terminal devices among the plurality of types of transmission-target terminal devices; and an image data storage control device (means) for controlling an image data storage device in such a manner that a plurality of items image data converted to image data of the formats of the plurality of types by the image data converting device are stored in association with data specifying corresponding transmission-target terminal devices among the plurality of types of transmission-target terminal devices.

The first aspect of the present invention also provides an operation control method suited to the above-described moving picture converting apparatus. Specifically, the method comprises the steps of: extracting audio data representing audio from moving-picture-with-audio data that represents a moving picture to which audio has been added; extracting image data representing an image from the moving-picture-with-audio data; converting the extracted audio data to audio data of formats of a plurality of types suitable for audio output in a plurality of types of transmission-target terminal devices to which the moving-picture-with-audio data is to be transmitted; converting the extracted image data to image data of formats of a plurality of types suitable for reproduction of a moving picture in the plurality of types of transmission-target terminal devices; controlling an audio data storage device in such a manner that a plurality of items of audio data converted to the audio data of the formats of the plurality of types are stored in association with data specifying corresponding transmission-target terminal devices among the plurality of types of transmission-target terminal devices; and controlling an image data storage device in such a manner that a plurality of items image data converted to image data of the formats of the plurality of types are stored in association with data specifying corresponding transmission-target terminal devices among the plurality of types of transmission-target terminal devices.

In accordance with the first aspect of the present invention, items of audio data representing audio and image data representing an image are each extracted from moving-picture-with-audio data. The extracted audio data is converted to audio data of formats of a plurality of types suitable for audio output in a plurality of types of transmission-target terminal devices that are the target of a transmission. The extracted image data is converted to image data of formats of a plurality of types suitable for reproduction of a moving picture in the plurality of types of transmission-target terminal devices. The items of audio data and image data resulting from the conversion are stored in an audio data storage device and image data storage device, respectively, in association with data specifying corresponding transmission-target terminal devices among the plurality of types of transmission-target terminal devices. The expression “corresponding transmission-target terminal device” means a terminal device suitable for an audio output that is based upon audio data and a terminal device suitable for moving-picture reproduction that is based upon image data.

When a request for transmission of moving-picture-with-audio data is sent from a requesting terminal device to the moving picture converting device, audio data suitable for output of audio in this requesting terminal device is read out of the audio data storage device and image data suitable for playback of a moving picture in the requesting terminal device is read out of the image data storage device. Moving-picture-with-audio data is generated from the audio data and image data read out. The generated moving-picture-with-audio data is transmitted to the requesting terminal device.

If the moving-picture-with-audio data comprising the audio data suitable for audio output and the image data suitable for playback of a moving picture is generated beforehand in association with a transmission-target terminal device (a requesting terminal device), N×M items of moving-picture-with-audio data will be required, where N represents the number of types of audio data suitable for audio output and M represents the number of types of image data suitable for playback of a moving picture. In accordance with the first aspect of the present invention, however, the moving-picture-with-audio data is generated by combining audio data and image data. Therefore, it will suffice if the number of items of moving-picture-with-audio data suitable for the transmission-target terminal device is N+M, namely the total number of N items of audio data and M items of image data. The amount of data storage capacity needed to store the audio data and image data is comparatively small. Since the moving-picture-with-audio data is generated by combining audio data and image data generated in advance, it can be generated comparatively quickly.

In a case where moving-picture-with-audio data onto which text data representing a character string has been added is handled, the apparatus further comprises a text data extracting device for extracting text data representing text from the moving-picture-with-audio data; a text data converting device for converting the text data extracted by the text data extracting device to text data of formats of a plurality of types suitable for display of the character string in the plurality of types of transmission-target terminal devices; and a text data storage control device for controlling a text data storage device in such a manner that a plurality of items of text data converted to the text data of the formats of the plurality of types by the text data converting device are stored in association with data specifying corresponding transmission-target terminal devices among the plurality of types of transmission-target terminal devices.

In a second aspect of the present invention, moving-picture-with-audio data suitable for reproduction in a transmission-requesting terminal device is generated from audio data and image data recorded in the first aspect of the present invention and transmitted to the transmission-requesting terminal device. A moving picture transmitting apparatus according to the second aspect of the present invention comprises: a receiving device (means) for receiving a request for transmission of moving-picture-with-audio data representing a moving picture to which audio has been added, the request being transmitted from a transmission-requesting terminal device; an audio data reading device (means) for reading audio data suitable for audio output in the transmission-requesting terminal device from an audio data storage device in which a plurality of items of audio data, which have been stored in association with formats of a plurality of types suitable for audio output in a plurality of types of transmission-target terminal devices to which the moving-picture-with-audio data is to be transmitted, have been stored for every corresponding transmission-target terminal device among the plurality of transmission-target terminal devices; an image data reading device (means) for reading image data suitable for reproduction of a moving picture in the transmission-requesting terminal device from an image data storage device in which a plurality of items of image data, which have been converted in association with a plurality of types of formats, have been stored for every corresponding transmission-target terminal device among the plurality of transmission-target terminal devices, the image data being suitable for reproduction of a moving picture in the transmission-target terminal devices and representing a moving picture from which audio has been eliminated; a generating device (means) for generating moving-picture-with-audio data from the audio data read by the audio data reading device and the image data read by the image data reading device; and a transmitting device (means) for transmitting the moving-picture-with-audio data generated by the generating device to the transmission-requesting terminal device.

The second aspect of the present invention also provides an operation control method suited to the above-described moving picture transmitting apparatus. Specifically, the method comprises the steps of: receiving a request for transmission of moving-picture-with-audio data representing a moving picture to which audio has been added, the request being transmitted from a transmission-requesting terminal device; reading audio data suitable for audio output in the transmission-requesting terminal device from an audio data storage device in which a plurality of items of audio data, which have been stored in association with formats of a plurality of types suitable for audio output in a plurality of types of transmission-target terminal devices to which the moving-picture-with-audio data is to be transmitted, have been stored for every corresponding transmission-target terminal device among the plurality of transmission-target terminal devices; reading image data suitable for reproduction of a moving picture in the transmission-requesting terminal device from an image data storage device in which a plurality of items of image data, which have been converted in association with a plurality of types of formats, have been stored for every corresponding transmission-target terminal device among the plurality of transmission-target terminal devices, the image data being suitable for reproduction of a moving picture in the transmission-target terminal devices and representing a moving picture from which audio has been eliminated; generating moving-picture-with-audio data from the read audio data and the read image data; and transmitting the generated moving-picture-with-audio data to the transmission-requesting terminal device.

Thus, moving-picture-with-audio data suitable for reproduction of a moving picture with audio in a transmission-requesting terminal device can be transmitted to the transmission-requesting terminal device.

The moving picture transmitting apparatus may further comprise a text data reading device for reading text data suitable for display of a character string in the transmission-requesting terminal device from a text data storage device in which a plurality of items of text data, which have been converted in association with a plurality of types of formats suitable for display of a character string in the transmission-target terminal devices, have been stored for every transmission-target terminal device among the plurality of transmission-target terminal devices. In this case, the generating device would generate moving-picture-with-audio data, in which the character string represented by the text data is displayed, from the audio data read by the audio data reading device, the image data read by the image data reading device and the text data read by the text data reading device.

The apparatus may further comprise a dividing device for dividing the audio data read by the audio data reading device and the image data read by the image data reading device in such a manner that moving-picture-with-audio data in an amount of data capable of being received at the transmission-requesting terminal device is generated. In this case, the generating device would generate divided moving-picture-with-audio data from the image data divided by the dividing device and divided audio data corresponding to the divided image data, and the transmitting device would transmit the divided moving-picture-with-audio data generated by the generating device to the transmission-requesting terminal device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a moving picture converting apparatus according to an embodiment of the present invention;

FIG. 2 illustrates selection information according to this embodiment;

FIG. 3 is a block diagram illustrating the electrical configuration of a moving picture transmitting apparatus according to this embodiment;

FIG. 4 is a block diagram illustrating the electrical configuration of a moving picture converting apparatus according to another embodiment of the present invention;

FIG. 5 is a block diagram illustrating the electrical configuration of a moving picture transmitting apparatus according to this embodiment; and

FIG. 6 is a block diagram illustrating the electrical configuration of a moving picture transmitting apparatus according to a further embodiment of the present invention.

### DESCRIPTION OF THE PREFERRED EMBODIMENTS

Preferred embodiments of the present invention will now be described in detail with reference to the drawings.

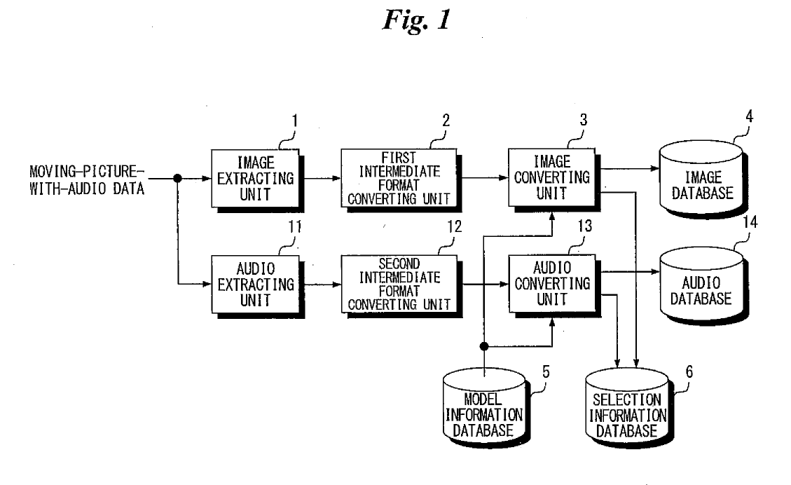

FIG. 1 is a block diagram illustrating the electrical configuration of a moving picture converting apparatus according to an embodiment of the present invention.

The moving picture converting apparatus according to this embodiment extracts audio data representing audio and image data representing a moving picture, from which audio has been removed, from moving-picture-with-audio data, and converts the extracted data to audio data and image data suitable for audio output and moving-picture reproduction, respectively, in a transmission-target terminal device to which moving-picture-with-audio data is to be transmitted.

Moving-picture-with-audio data that has been input to the moving picture converting apparatus is input to an image extracting unit 1 and audio extracting unit 11. The image extracting unit 1 extracts image data, which represents a moving picture from which audio data has been removed, from the moving-picture-with-audio data and inputs the image data to a first intermediate format converting unit 2. The audio extracting unit 11 extracts audio data from the moving-picture-with-audio data and inputs the audio data to a second intermediate format converting unit 12.

If the moving-picture-with-audio data has been compressed, the first intermediate format converting unit 2 expands the data to obtain image data in which each frame of a number of frames of a subject image constituting a moving picture represents one frame of the subject image. Similarly, the second intermediate format converting unit 12 converts the compressed audio data to audio data that is based upon PCM (Pulse Code Modulation). Image data that has been output from the first intermediate format converting unit 2 is input to an image converting unit 3, and audio data that has been output from the second intermediate format converting unit 12 is input to an audio converting unit 13.

Model information from a model information database 5 is applied to the image converting unit 3 and audio converting unit 13. Model information that has been stored in the model information database 5 is information indicating an image format suitable for playback of a moving picture in a transmission-target terminal device, and information indicating an audio format suitable for audio output in the transmission-target terminal device. For example, information regarding an audio encoding scheme, moving picture encoding scheme, audio bit rate (32 kbps, 64 kbps, etc.), moving picture bit rate (64 bps, 128 bps, 192 bps, etc.), moving picture frame rate, audio sampling frequency, display resolution, number of audio channels (monaural or stereo) and system encoding (multiplexing of moving picture data without accompanying audio and audio data) is stored as model information in the model information database 5 per model of transmission-target terminal device.

The model information that has been stored in the model information database 5 is applied to the image converting unit 3, as mentioned above. On the basis of the model information applied, the image converting unit 3 generates image data having a number of formats suitable for moving-picture playback in respective ones of a number of terminal devices to which a transmission is to be made. Similarly, the model information is applied to the audio converting unit 13. On the basis of the model information applied, the audio converting unit 13 generates audio data having a number of formats suitable for audio output in respective ones of a number of terminal devices to which a transmission is to be made. The generated image data having the number of formats is stored in an image database 4, and the generated audio data having the number of formats is stored in an audio database 14.

The image converting unit 3 and audio converting unit 13 output also output selection information indicating in which model of transmission-target terminal device the generated image data and audio data having the number of formats is utilized. The selection information is applied to a selection information database 6 and recorded for every transmission-target terminal device.

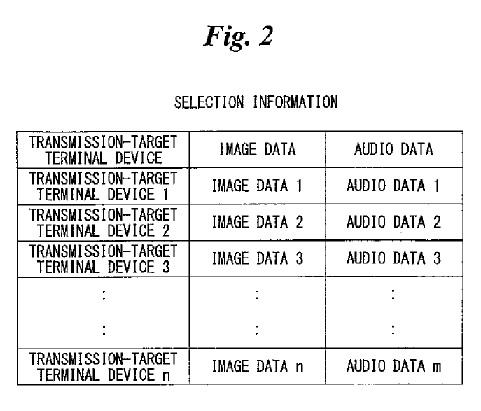

FIG. 2 illustrates an example of selection information that has been stored in the selection information database 6.

Image data and audio data utilized by each of the transmission-target terminal devices has been stored for every transmission-target terminal device in the selection information database 6. For example, data to be utilized by “TRANSMISSION-TARGET TERMINAL DEVICE 1” is “IMAGE DATA 1” and “AUDIO DATA 1”. In a case where a request for transmission of moving-picture-with-audio data has been issued by “TRANSMISSION-TARGET TERMINAL DEVICE 1”, it will be understood based upon the selection information database 6 that “IMAGE DATA 1” and “AUDIO DATA 1” is utilized, “IMAGE DATA 1” is read from the image data of the number of formats stored in the image database 4, and “AUDIO DATA 1” is read from the audio data of the number of formats stored in the audio database 14. The “IMAGE DATA 1” that has been read out is suitable for reproducing a moving picture in the terminal device that issued the transmission request, and the “AUDIO DATA 1” that has been read out is suitable for audio output in this terminal device. As will be described later, moving-picture-with-audio data is generated from the “IMAGE DATA 1” and “AUDIO DATA 1” read out and is transmitted to the terminal device that issued the transmission request.

Thus, in this embodiment of the present invention, moving-picture-with-audio data that is suitable for playback of moving-picture-with-audio data in a transmission-target terminal device is stored upon being split into audio data and image data that represents a moving picture from which audio data has been removed. When the moving-picture-with-audio data is transmitted, the moving-picture-with-audio data is generated from the audio data and image data. Therefore, in comparison with a case where moving-picture-with-audio data is generated and stored in advance for every model of transmission-target terminal device, smaller storage capacities will suffice for the databases that store the data. For example, assume that the formats for image data are of three types for the bit rates of 64 kbps, 128 kbps and 192 kbps, and that the formats for audio data are of four types, namely bits rates of 32 kbps and 64 kbps for monaural and 32 kbps and 64 kbps for stereo. In such case, moving-picture-with-audio data of 12 types, namely 3 types×4 types, would be required conventionally. In this embodiment, however, it will suffice to store data (audio data and image data) of seven types, namely 3 types+4 types. This means that the amount of data stored in advance is reduced to approximately half ( 7/12).

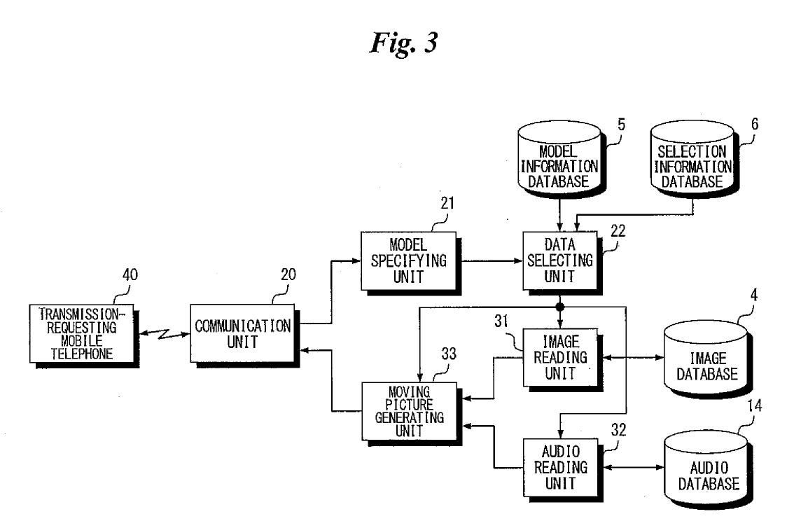

FIG. 3 is a block diagram illustrating the electrical configuration of a moving picture transmitting apparatus for transmitting moving-picture-with-audio data to a terminal device (a transmission-requesting mobile telephone) that requests transmission, the moving-picture-with-audio data being generated from image data and audio data stored in the manner described above.

Components in FIG. 3 identical with those shown in FIG. 1 are designated by like reference characters. Although the moving picture transmitting apparatus shown in FIG. 3 is depicted as being separate from the moving picture converting apparatus illustrated in FIG. 1, the moving picture converting apparatus shown in FIG. 1 and the moving picture transmitting apparatus shown in FIG. 3 may be combined into a single apparatus.

As described above, model information has been stored in the model information database 5, selection information has been stored in the selection information database 6, image data of a number of formats representing an image from which audio has been removed is stored in the image database 4, and audio data of a number of formats has been stored in the audio database 14.

A request for transmission of desired moving-picture-with-audio data from a transmission-requesting mobile telephone 40 is received by a communication unit 20 of the moving picture transmitting apparatus. The transmission request is input in a file format to a model specifying unit 21. The header of the file indicating the transmission request contains user agent information that includes the model information of the transmission-requesting mobile telephone 40. On the basis of the user agent information, the model specifying unit 21 specifies the model of the transmission-requesting mobile telephone 40. Data representing the specified model is applied to a data selecting unit 22.

The formats of the image data and audio data suitable for the specified model are read from the selection information database 6 by the data selecting unit 22. An image reading unit 31 is controlled by the data selecting unit 22 in such a manner that image data having the read format is read from the image database 4. Similarly, an audio reading unit 32 is controlled by the data selecting unit 22 in such a manner that audio data having the format read from the selection information database 6 is read from the audio database 14.

The image data read by the image reading unit 31 and the audio data read by the audio reading unit 32 is applied to a moving picture generating unit 33. Information indicating system encoding (the multiplexing scheme) corresponding to the model specified by the model specifying unit 21 is read from the model information database 5. The read information indicating the system encoding also is applied to the moving picture generating unit 33. The image data and the audio data is encoded by the moving picture generating unit 33 based upon the encoding scheme that is based upon the applied information indicating the system encoding. The moving-picture-with-audio data generated by encoding is transmitted to the transmission-requesting mobile telephone 40 by the communication unit 20. The moving-picture-with-audio data received by the transmission-requesting mobile telephone 40 is data that has been adapted to the audio output scheme of the transmission-requesting mobile telephone 40 and to the reproduction of the moving picture. Since system encoding generally involves a small amount of processing in comparison with image conversion and audio conversion, real-time processing can be executed.

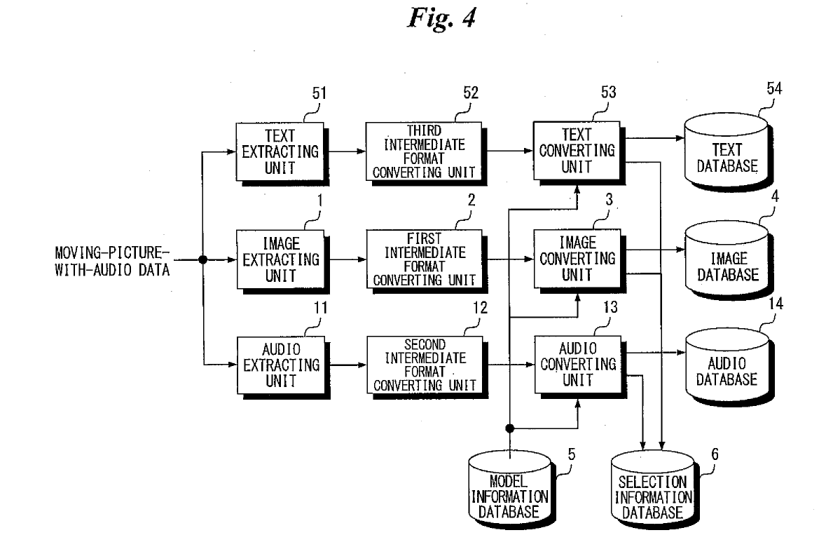

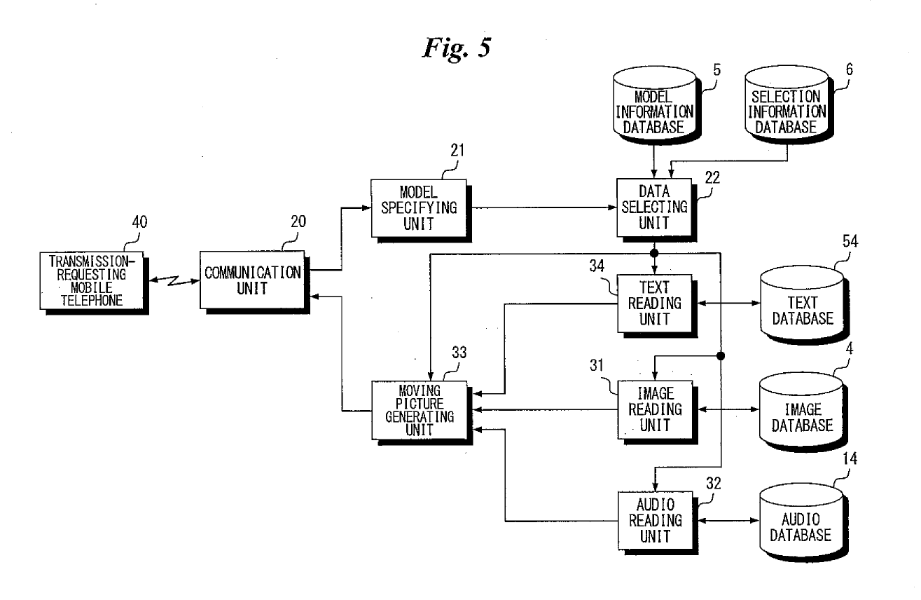

FIGS. 4 and 5 illustrate another embodiment of the invention. This embodiment relates to a case where text data for displaying a character string has been added to a moving picture represented by moving-picture-with-audio data.

FIG. 4 corresponds to FIG. 1 and is a block diagram illustrating the electrical configuration of a moving picture converting apparatus. Components in FIG. 4 identical with those shown in FIG. 1 are designated by like reference characters.

The moving picture converting apparatus includes a text extracting unit 51. Moving-picture-with-audio data to which text data has been added is input to the text extracting unit 51, whereby text data is extracted. The text data, such as telop, is added to the moving picture data based upon a timed text format. The extracted text data is input to a third intermediate format converting unit 52. Text data that has been compressed is expanded by the third intermediate format converting unit 52 and input to a text converting unit 53.

Information concerning text data (e.g., the text encoding scheme, text bit rate, areas where text can be displayed, etc.) suitable for display of a character string in transmission-target terminal devices has been stored in the model information database 5 in addition to the model information regarding the image data and audio data in association with the transmission-target terminal devices in the manner described above. The information concerning the text data that has been stored in the model information database 5 is applied to the text converting unit 53, whereby text data suitable for display of a character string in a plurality of transmission-target terminal devices is generated. The generated text data is applied to and recorded in a text database 54. Further, data indicating the type of text data suitable for the transmission-target terminal devices also is applied to and recorded in the selection information database 6 in a manner similar to the image data and audio data.

FIG. 5 corresponds to FIG. 3 and is a block diagram illustrating the electrical configuration of a moving picture transmitting apparatus. Components in FIG. 5 identical with those shown in FIG. 3 are designated by like reference characters.

As described above, text data suitable for display of a character string in a plurality of transmission-target terminal devices has been stored in the text database 54. When the model of the transmission-requesting mobile telephone 40 is specified by the model specifying unit 21, selection information for specifying the text data suitable for display of the character string by the specified model is read from the selection information database 6. On the basis of the selection information read, text data suitable for display of the character string in the transmission-requesting mobile telephone 40 is read from the text database 54 by a text reading unit 34.

The read text data, image data and audio data is applied to the moving picture generating unit 33, which proceeds to generate moving-picture-with-audio data to which text data has been added. The generated moving-picture-with-audio data is transmitted to the transmission-requesting mobile telephone 40.

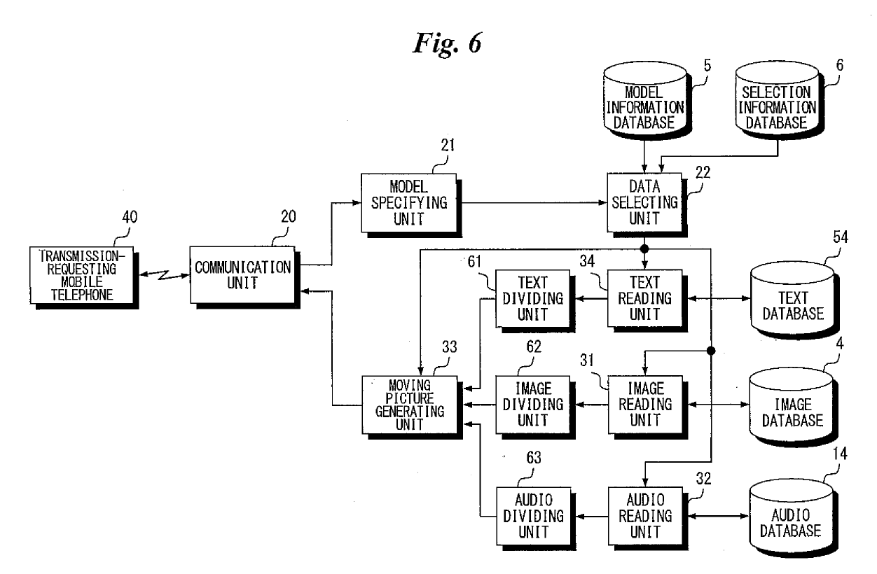

FIG. 6 is a block diagram illustrating the electrical configuration of a moving picture transmitting apparatus according to a further embodiment of the present invention. Components in FIG. 6 identical with those shown in FIG. 5 are designated by like reference characters.

This embodiment is so adapted that even if the amount of data in the moving-picture-with-audio data generated as described above is greater than an amount that the transmission-requesting mobile telephone 40 is capable of receiving, the transmission-requesting mobile telephone 40 can receive the requested moving-picture-with-audio data. In this case, it goes without saying that the amount of data that can be received by the transmission-target terminal device and the playback time are also recorded in the model information database 5.

The items of text data read by the text reading unit 34, image data read by the image reading unit 31 and audio data read by the audio reading unit 32 are input to a text dividing unit 61, image dividing unit 62 and audio dividing unit 63, respectively. The amount of data that can be received by the transmission-requesting mobile telephone 40 stored in the model information database 5 also is applied to the text dividing unit 61, image dividing unit 62 and audio dividing unit 63. The items of text data read by the text reading unit 34, image data read by the image reading unit 31 and audio data read by the audio reading unit 32 are divided by the text dividing unit 61, image dividing unit 62 and audio dividing unit 63, respectively, in such a manner that the amount of data in the moving-picture-with-audio data onto which the text data has been added, and which has been generated by the moving picture generating unit 33, will not exceed the amount of data capable of being received by the transmission-requesting mobile telephone 40.

The portions of the text data, image data and audio data resulting from division by the text dividing unit 61, image dividing unit 62 and audio dividing unit 63, respectively, are applied to the moving picture generating unit 33, which proceeds to generate one portion of moving-picture-with-audio data. This portion of moving-picture-with-audio data is transmitted to the transmission-requesting mobile phone 40. When the playback of the moving picture part represented by this portion of moving-picture-with-audio data is finished in the transmission-requesting mobile phone 40, a request for transmission of the remaining data is transmitted from the transmission-requesting mobile phone 40 to the moving picture transmitting apparatus. One portion of remaining moving-picture-with-audio data is transmitted from the moving picture transmitting apparatus to the transmission-requesting mobile phone 40.

As for the dividing of the data in the text dividing unit 61, image dividing unit 62 and audio dividing unit 63, all of the moving-picture-with-audio data may be divided into a number of items specified such that the amount of data will be an amount stipulated by the model information identifying the transmission-requesting mobile telephone 40; the moving-picture-with-audio data may be divided from the beginning portion thereof into a number of items specified such that the amount of data will be an amount stipulated by the model information identifying the transmission-requesting mobile telephone 40; or the moving-picture-with-audio data may be divided not from the beginning portion but from a desired portion thereof into a number of items specified such that the amount of data will be an amount stipulated by the model information identifying the transmission-requesting mobile telephone 40. If the data will fall within the amount of data that the transmission-requesting mobile telephone 40 can receive, then the amount of data divided and the number of portions in which the data is divided can be set freely. The setting may be made by a content provider or observer who possesses the moving-picture-with-audio data and has the right to transmit it.

Furthermore, in a case where moving-picture-with-audio data is transmitted upon being divided, it may be so arranged that after multiplexing and transmitting is performed using the divided portions of the data in the manner described above, an HTML (HyperText Markup Language) file containing a link to the next portion of data is transmitted to the transmission-requesting mobile telephone 40, and the next portion of the moving-picture-with-audio data is transmitted in response to a request. Further, it may be so arranged that an HTML file containing links for specifying respective divided portions of the moving-picture-with-audio data is transmitted to the transmission-requesting mobile telephone 40, and a portion of the moving-picture-with-audio data conforming to the request from the transmission-requesting mobile telephone 40 is transmitted to the transmission-requesting mobile telephone 40. Further, it may be so arranged that an HTML file in which the observer is capable of specifying an interval as by a time code is transmitted to the transmission-requesting mobile telephone 40, and the portion of the moving-picture-with-audio data in the specified interval is generated and transmitted to the transmission-requesting mobile telephone 40. Thus, only the necessary portion is subjected to multiplexing processing.

Although the embodiments described above are implemented using hardware, it may be so arranged that the can be implemented using software.

As many apparently widely different embodiments of the present invention can be made without departing from the spirit and scope thereof, it is to be understood that the invention is not limited to the specific embodiments thereof except as defined in the appended claims.

What is claimed is:

1. A moving picture converting apparatus comprising:
an audio data extracting device for extracting audio data representing audio from moving-picture-with-audio data that represents a moving picture to which audio has been added;
an image data extracting device for extracting image data representing an image from the moving-picture-with-audio data;
an audio data converting device for converting the audio data that has been extracted by said audio data extracting device to audio data of formats of a plurality of types suitable for audio output in a plurality of types of transmission-target terminal devices to which the moving-picture-with-audio data is to be transmitted;
an image data converting device for converting the image data that has been extracted by said image data extracting device to image data of formats of a plurality of types suitable for reproduction of a moving picture in the plurality of types of transmission-target terminal devices;
an audio data storage control device for controlling an audio data storage device in such a manner that a plurality of items of audio data converted to the audio data of the formats of the plurality of types by said audio data converting device are stored in association with data specifying corresponding transmission-target terminal devices among the plurality of types of transmission-target terminal devices; and
an image data storage control device for controlling an image data storage device in such a manner that a plurality of items image data converted to image data of the formats of the plurality of types by said image data converting device are stored in association with data specifying corresponding transmission-target terminal devices among the plurality of types of transmission-target terminal devices.

2. The apparatus according to claim 1, wherein text data representing a character string has been added onto the moving-picture-with-audio data, and said apparatus further comprises:
a text data extracting device for extracting text data representing text from the moving-picture-with-audio data;
a text data converting device for converting the text data extracted by said text data extracting device to text data of formats of a plurality of types suitable for display of the character string in the plurality of types of transmission-target terminal devices; and
a text data storage control device for controlling a text data storage device in such a manner that a plurality of items of text data converted to the text data of the formats of the plurality of types by said text data converting device are stored in association with data specifying corresponding transmission-target terminal devices among the plurality of types of transmission-target terminal devices.

3. A moving picture transmitting apparatus comprising:
a receiving device for receiving a request for transmission of moving-picture-with-audio data representing a moving picture to which audio has been added, the request being transmitted from a transmission-requesting terminal device;
an audio data reading device for reading audio data suitable for audio output in the transmission-requesting terminal device from an audio data storage device in which a plurality of items of audio data, which have been stored in association with formats of a plurality of types suitable for audio output in a plurality of types of transmission-target terminal devices to which the moving-picture-with-audio data is to be transmitted, have been stored for every corresponding transmission-target terminal device among the plurality of transmission-target terminal devices;
an image data reading device for reading image data suitable for reproduction of a moving picture in the transmission-requesting terminal device from an image data storage device in which a plurality of items of image data, which have been converted in association with a plurality of types of formats, have been stored for every corresponding transmission-target terminal device among the plurality of transmission-target terminal devices, the image data being suitable for reproduction of a moving picture in the transmission-target terminal devices and representing a moving picture from which audio has been eliminated;
a generating device for generating moving-picture-with-audio data from the audio data read by said audio data reading device and the image data read by said image data reading device; and
a transmitting device for transmitting the moving-picture-with-audio data generated by said generating device to the transmission-requesting terminal device.

4. The apparatus according to claim 3, further comprising:
a text data reading device for reading text data suitable for display of a character string in the transmission-requesting terminal device from a text data storage device in which a plurality of items of text data, which have been converted in association with a plurality of types of formats suitable for display of a character string in the transmission-target terminal devices, have been stored for every transmission-target terminal device among the plurality of transmission-target terminal devices;
wherein said generating device generates moving-picture-with-audio data, in which the character string represented by the text data is displayed, from the audio data read by said audio data reading device, the image data read by said image data reading device and the text data read by said text data reading device.

5. The apparatus according to claim 3, further comprising a dividing device for dividing the audio data read by said audio data reading device and the image data read by said image data reading device in such a manner that moving-picture-with-audio data in an amount of data capable of being received at the transmission-requesting terminal device is generated;
wherein said generating device generates divided moving-picture-with-audio data from the image data divided by said dividing device and the divided audio data corresponding to the divided image data; and
said transmitting device transmits the divided moving-picture-with-audio data generated by said generating device to the transmission-requesting terminal device.

6. A method of controlling operation of a moving picture converting apparatus, comprising the steps of:
extracting audio data representing audio from moving-picture-with-audio data that represents a moving picture to which audio has been added;
extracting image data representing an image from the moving-picture-with-audio data;
converting the extracted audio data to audio data of formats of a plurality of types suitable for audio output in a plurality of types of transmission-target terminal devices to which the moving-picture-with-audio data is to be transmitted;
converting the extracted image data to image data of formats of a plurality of types suitable for reproduction of a moving picture in the plurality of types of transmission-target terminal devices;
controlling an audio data storage device in such a manner that a plurality of items of audio data converted to the audio data of the formats of the plurality of types are stored in association with data specifying corresponding transmission-target terminal devices among the plurality of types of transmission-target terminal devices; and
controlling an image data storage device in such a manner that a plurality of items image data converted to image data of the formats of the plurality of types are stored in association with data specifying corresponding transmission-target terminal devices among the plurality of types of transmission-target terminal devices.

7. A method of controlling operation of a moving picture transmitting apparatus, comprising the steps of:
receiving a request for transmission of moving-picture-with-audio data representing a moving picture to which audio has been added, the request being transmitted from a transmission-requesting terminal device;
reading audio data suitable for audio output in the transmission-requesting terminal device from an audio data storage device in which a plurality of items of audio data, which have been stored in association with formats of a plurality of types suitable for audio output in a plurality of types of transmission-target terminal devices to which the moving-picture-with-audio data is to be transmitted, have been stored for every corresponding transmission-target terminal device among the plurality of transmission-target terminal devices;
reading image data suitable for reproduction of a moving picture in the transmission-requesting terminal device from an image data storage device in which a plurality of items of image data, which have been converted in association with a plurality of types of formats, have been stored for every corresponding transmission-target terminal device among the plurality of transmission-target terminal devices, the image data being suitable for reproduction of a moving picture in the transmission-target terminal devices and representing a moving picture from which audio has been eliminated;
generating moving-picture-with-audio data from the read audio data and the read image data; and
transmitting the generated moving-picture-with-audio data to the transmission-requesting terminal device.
